(19) United States
(12) Patent Application Publication
(10) Pub. No.: US 2012/0303332 A1
(43) Pub. Date: Nov. 29, 2012

(54) ESTIMATING FORCES ON COMPLEX SURFACES

(75) Inventor: William H. Mangione-Smith, Kirkland, WA (US)

(73) Assignee: EMPIRE TECHNOLOGY DEVELOPMENT LLC, Wilmington, DE (US)

(21) Appl. No.: 13/002,249

(22) PCT Filed: Apr. 28, 2010
(86) PCT No.: PCT/US10/32687

§ 371 Date: Apr. 25, 2011

(51) Int. Cl. G06F 17/50

(52) U.S. Cl. 703/1

(57) ABSTRACT

Techniques for constructing an enhanced model of an object are provided. Sensor data is received from a sensor network that is arranged on the surface of the object. The sensor data includes measurements of surface conditions that the surface of the object experiences. Pressure data, which correlates to locations on the enhanced model, is determined from the sensor data. The enhanced model is enhanced with the pressure data.

### BACKGROUND

A wide range of sensor technologies has been proposed and developed to enable pressure sensing applications under various conditions. When applied to irregular surfaces, however, these applications have had unsatisfactory results. For example, attempts have been made to sense the pressure felt over the entire surface of a human hand or over other objects with irregular surfaces.

A number of open problems exist (e.g., sensor thinness, reliability, wiring, etc.) when sensing the pressure over an irregular source. Some of these problems are a direct consequence of the irregular surface conditions. In the context of a human hand, for example, each human hand is different. Hands come in different sizes, shapes, and often have variable characteristics. As a result, it is difficult to construct a system that can easily be applied to a number of different people and perform well for each person. In general, conventional solutions fail to account for these differences and also fail to account for the deforming effects of force application.

### SUMMARY

Embodiments relate to constructing a model of a surface of an object. In one embodiment, a method for constructing a model of a surface of an object includes receiving sensor data from a sensor network that is arranged on the surface of the object. The sensor network is arranged on the surface to measure surface conditions in multiple dimensions. The sensor data includes measurements of the surface conditions. Pressure data is then determined from the sensor data and correlated to locations in the model. The model of the surface of the object is then generated by enhancing an initial model of the surface of the object with the pressure data. The model includes the surface conditions measured by the sensor network.

In another embodiment, a system for constructing an enhanced model of a surface of an object may include a sensor device, a sensor module, and a three-dimensional module. The sensor device includes a sensor network that can be arrayed on the surface of the object. The sensor network may include multiple sensors that are arrayed on the surface of the object and interconnected with multiple connections. The sensor data may include measurements or estimates of the forces experienced by the connections and/or the sensors in the sensor network. The sensor data can reflect the directions of the forces in multiple directions. The sensor module is configured to receive sensor data from the sensor network. The sensor module can determine pressure data from the sensor data. The three-dimensional module is configured to update the enhanced model with the pressure data, which can be correlated to locations in the enhanced model.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 shows an illustrative embodiment of a system for constructing an enhanced model of a surface of an object;

FIG. 2 shows an illustrative embodiment of sensors that are arranged in a sensor network;

FIG. 3 shows an illustrative embodiment of another sensor network;

FIG. 4 shows an illustrative embodiment of a system for enhancing a model of an object using sensor data received from sensor networks that are arranged on a surface of the object;

FIG. 5 is a flow diagram of an illustrative embodiment of a method for generating a pressure mapped surface of an object;

FIG. 6 is a flow diagram of an illustrative embodiment of a method for constructing an enhanced model of a surface of an object; and

FIG. 7 shows an example computing device that is arranged for constructing a model of a surface of an object or for enhancing a model of the surface of the object in accordance with the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

Disclosed embodiments relate to constructing enhanced models of an object and/or of surfaces of the object. The enhanced models disclosed herein can include pressure-enhanced maps. The construction of an enhanced model may include augmenting initial models with physical properties, such as elasticity and surface tension, which are determined from sensor data received from a sensor device.

Sensors in the sensor device collect the sensor data that relates to the physical properties. In other words, the sensor data is a measurement of the surface conditions, such as forces, in multiple dimensions. The sensor data can be combined with elemental measurements to produce a more accurate or enhanced model of the object or of the surface of the object. For example the initial measurements of the physical hand will create an elemental mesh that models the physical hand along with a measure of the spring coefficient and nonlinear elasticity properties between mesh elements. These factors produce a simple mechanical model of how the elemental mesh deforms under applied force.

The enhanced models, which include three-dimensional models, have a wide application to a range of interactive haptic systems, including telemedicine, virtual reality, remote maintenance, robotics and computer gaming. The enhanced models provide surface conditions that can improve such haptic systems. Embodiments can be incorporated into a computing infrastructure that is used to process the sensor data.

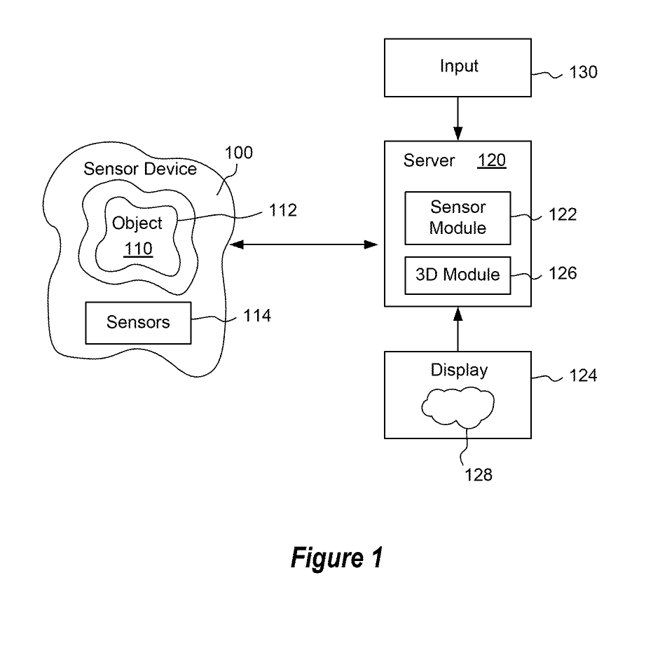

FIG. 1 shows an illustrative embodiment of a system for constructing an enhanced model of a surface of an object. FIG. 1 illustrates a sensor device 100 that has been placed on a surface 112 of an object 110. When placing the sensor device 100 on the surface 112, sensors 114 in the sensor device 100 are often tightly spaced enough to obtain an accurate reading of surface conditions, including forces that are being applied to the surface 112 in multiple dimensions. The sensors 114 can have varying accuracies. Coarse sensors 114 and/or coarse sensing applications can use sensors including mechanical attachments of spring devices and cover spacing on the order of tens of centimeters, while finer grained sensors 114 (such as MEMS devices) can be spaced with a sub-millimeter pitch.

To measure the surface conditions, the sensors 114 are configured to measure forces that the surface 112 of the object 110 experiences. One of skill in the art can appreciate that other sensors may be configured to measure other aspects of the surface 112 that can be included or represented in an enhanced model 128 of the surface 112 of the object 110. The sensors 114 may include those that are configured to measure, by way of example only, temperature or moisture.

The sensors 114 can be placed or arranged on specific locations of the surface 112 of the object 110. The locations of the sensors 114 are registered and correspond to the same locations on the enhanced model 128. The sensors 114 can also be grouped together in sensor networks. Arranging the sensors 114 in sensor networks enables the sensors 114 to collect sensor data that is representative of surface conditions in multiple dimensions. The surface conditions measured by the sensors 114 may include forces, by way of example only, that include pressure, surface elasticity, and/or tension. The sensors 114 can be configured to measure or collect data on an individual basis, on a sensor-network basis, and/or on an inter-network basis. The sensors 114 can also be powered in a similar manner.

The sensors 114 can include piezoelectric devices, optical stress devices that use polymers, electro-mechanical stress devices, stress dependent potentiometers, spring tension devices with electrical pickup, or the like, or any combination thereof. The sensor device 100 collects sensor data from the sensors 114 and provides the sensor data to a server 120.

The server 120 can operate the sensor device 100 and/or the sensors 114 remotely. The server 120 can collect the sensor data from individual sensors, from sensor networks, or the like, or any combination thereof.

The server 120 includes a sensor module 122 that is configured to process the sensor data to estimate the surface conditions, including forces, experienced by the surface 112 of the object 110. As previously stated, the sensors 114 are registered with the enhanced model 128. The server 120 may maintain a database such that the server 120 can correlate the sensor data received from the sensors 114 with the registered locations of the sensors 114.

The surface conditions determined by the sensor module 122 can be provided to a three-dimensional (3D) module 126. The 3D module 126 receives the surface conditions determined by the sensor module 122 and, in one example, generates the enhanced model 128 of the object 110 and/or the surface 112 that can be presented on a display 124, delivered to a remote location, or the like.

FIG. 1 also illustrates an input 130 to the server 120, which can include an initial model of the object 110 and/or of the surface 112. The input 130 can also include factors that alter the characteristics of the enhanced model 128 before and/or after the enhanced model 128 is augmented with information derived or determined from the sensor data. For example auxiliary spatial input could indicate some degree of physical separation between two elements, for example as a consequence of optical imaging.

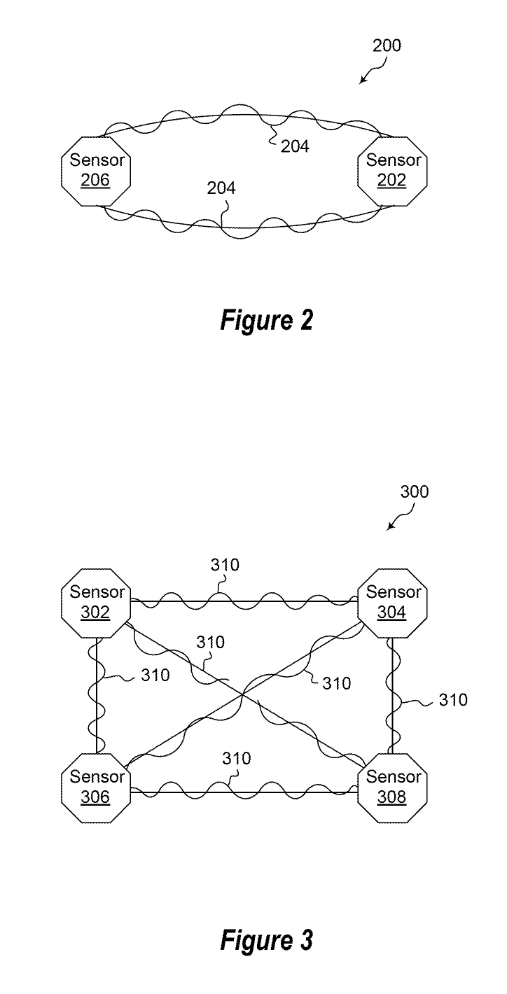

FIG. 2 shows an illustrative embodiment of sensors that are arranged in a sensor network. As depicted, a sensor network 200 includes a sensor 202 and a sensor 206. The sensors 202 and 206 can be the same type of sensor or different types of sensors. The sensors 202 and 206 can also be the same type of sensor, but configured differently.

The sensors 202 and 206, for example, can be piezoelectric devices, optical stress devices that use polymers, electro-mechanical stress devices, stress dependent potentiometers, spring tension devices with electrical pickup, or the like, or any combination thereof as previously described.

FIG. 2 further illustrates connections 204, which connect the sensor 202 with the sensor 206 to form the sensor network 200. In the sensor network 200, the sensors 202 and 206 are connected with multiple connections 204. The connections 204 are generally formed from a material having characteristics that are known. For example, the connections 204 may be formed from a material such as an elastomeric polymer, plastic or metallic spring, or cantilever beams whose elasticity (e.g., linear displacement properties and spring coefficient) is known.

When measuring the surface conditions, the sensor 202 may determine a distortion in the connections 204. The distortion is thus a measurement of the force applied to the surface 112. The sensor 202 can also determine direction of the force. For example, the sensor 202 can distinguish between a compression of the connections 204 and an expansion of the connections 204. This distortion is stored as part of the sensor data. The sensor 202 may also be able to measure pressure applied to the sensor itself, which pressure is also included in the sensor data. According to the embodiment illustrated in FIG. 2, sensor 202 has two connections 204. The relative difference between the distortions in these connections 204 can result in data that indicates direction of the force. The sensor 202 performs these types of measurements and may store the measurements as sensor data. Alternatively, the sensor data may be provided to the server 120 as the surface conditions are sensed.

The sensors 202 and 206 are examples of sensors that may be included in the sensors 114 and placed on the surface 112 of the object 110. The sensors 202 and 206 can then measure the stress between the sensors 202 and 206 caused by distortion of the connections 204 as previously described.

FIG. 3 shows an illustrative embodiment of another sensor network. As depicted, a sensor network 300 includes sensors 302, 304, 306, and 308, which are further examples of the sensor 202 and/or the sensor 206 and/or of the sensors 114. In the sensor network 300, each of the sensors 302, 304, 306, and 308 is connected to each of the other sensors by the connections 310, which are further examples of the connections 204. One of skill in the art can appreciate, with the benefit of the present disclosure, that the sensors 302, 304, 306, and 308 can be arranged in other configurations that provide the functions and results described herein. In general, sensor networks that operate according to the principles disclosed herein are not limited to those that include only two or only four sensors.

Further, the sensors 302, 304, 306, and 308 in the sensor network 300 can be connected in different configurations. The sensor 302, for example, may only be connected to the sensor 304 while the sensors 304, 306, and 308 are all connected to each other. The sensor data generated by the sensor network 300 can be collected as it is generated. The sensors 302, 304, 306, and 308 may collect or generate sensor data in a manner similar to the sensor 202.

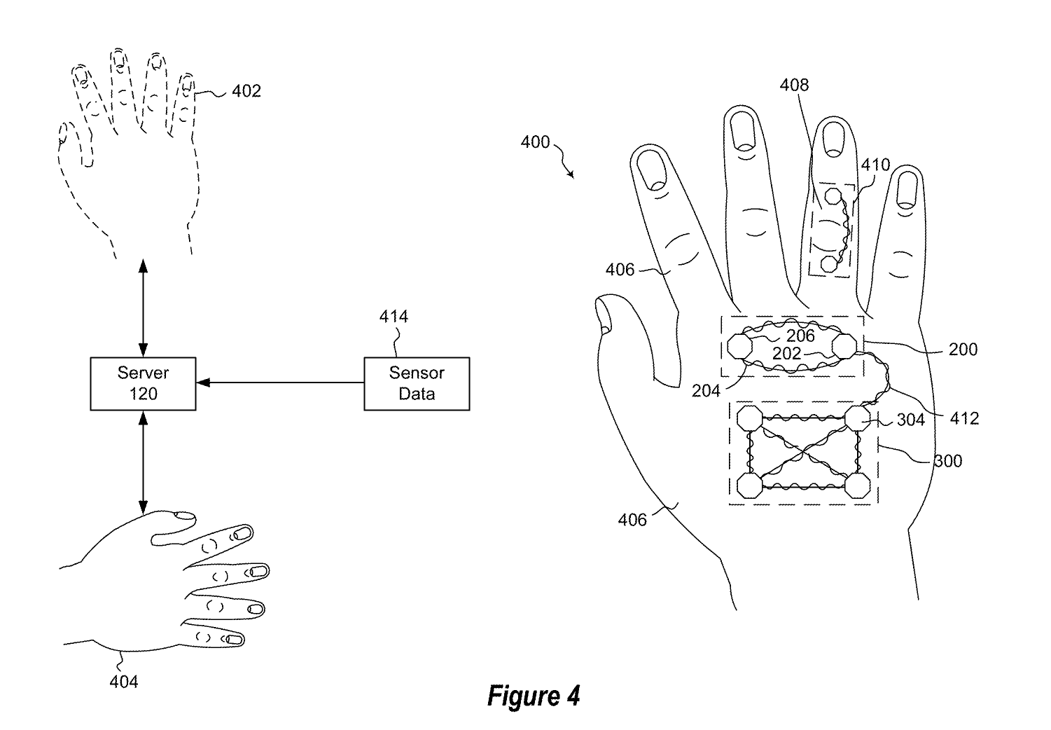

FIG. 4 shows an illustrative embodiment of a system for enhancing a model of an object using sensor data received from sensor networks that are arranged on a surface of the object. According to an aspect of the present disclosure, FIG. 4 shows a hand 400, which is an example of the object 110. In this example, the hand 400 is animate, but the object 110 can be animate or inanimate, depending on the environment in which the sensor data is to be obtained. A surface 406 of the hand 400 includes irregular surfaces, such as an irregular surface 408. According to this example, a sensor network 410 is arranged on the surface 406, over the irregular surface 408. The sensor networks 200 and 300 have also been arranged on the surface 406 of the hand 400 over, for example, irregular surfaces of the hand 400.

The hand 400 can be modeled, by an initial model 402, and forces on the hand 400 can be estimated using techniques known to those of ordinary skill in the art, including, but not limited to, computer-aided design (CAD) modeling tools. For example, one type of force that can be measured is pressure, which can be defined as the force per unit area applied in a direction perpendicular to the subject surface (e.g., surface 406). Pressure can be measured using a number of physical sensors such as, but not limited to, piezoelectric structures. A second example of a measurable force is strain measured with MEMS strain gauges of various technologies. A third example includes the use of interferometery applied to optically transparent materials with differing Young's modulus.

The initial model 402 is augmented with sensor data 414 to produce an enhanced model 404, which reflects surface conditions of the surface 406. More specifically, the enhanced model 404 can be updated with the sensor data 414 to illustrate the forces that the surface 406 experiences. Hooke's Law for spring force can be used to provide a simple initial model of displacement between model mesh points where F=−kX, F corresponds to the measured force, k corresponds to the spring constant identified a priori, and X is the displacement to be solved for. This approach is applied to all of the forces measured on the entire surface to produce an over-constrained system of linear equations which can be solved concurrently to produce the updated location of mesh elements and thus an updated model of the physical hand location, orientation, distortion, and flexion.

FIG. 4 illustrates that the sensor network 200 is connected with the sensor network 300 by a connection 412. The connection 412 may be similar to the connection 204 and enable the sensor networks 200 and 300 (or the sensors 202 and 304) to measure surface conditions of the surface 406. For instance, the sensor 202, the sensor 304, and the connection 412 can be used to determine the surface conditions relative to the locations on the enhanced model 404 that correspond to the locations of the sensors 202 and 304.

In FIG. 4, the sensors in the sensor networks 200, 300, and 410 (e.g., the sensors 202, 206, and 304) can be configured to measure forces. As previously described, the sensors 202 and 206 may be piezoelectric sensors that are connected by one or more connections 204. The elasticity of the connections 204 may be determined when the sensor network 200 is configured (or at any other suitable time) and placed on the surface 406. In addition, the elasticity of the connections 204 may be known based on the material(s) used in the connections 204. Any distortion or change in the connections 204 can be measured by the sensors 202 and 206. Similarly, distortions in the connection 412 can be measured by at least one of the sensors 202 and 304.

The configurations of the sensor networks 200, 300, and 410 enable the sensor networks 200, 300, and 410 to sense forces in three dimensions. More specifically, in this example, the surface 406 is not planar and the sensor networks 200, 300, and 410 are not restricted to planar surfaces. Thus, the force(s) on the surface 406 are not only being sensed discretely by each individual sensor in the sensor networks 200, 300, and 410, but are also being sensed dimensionally. In other words, the pressure generated when the sensor 202 pulls/pushes on the sensor 206 (via the connections 204) adds an additional sensing dimension that can be measured by the sensors 202 and 206, and more generally by the sensor networks 200, 300, and 410. The connections, such as the connections 204, between sensors in the sensor networks 200, 300, and 410 and between sensor networks can help determine surface conditions (e.g., forces such as surface tension) between the sensors 202 and 206, thereby providing more sensor data than using discrete sensor monitoring.

The sensor networks 200, 300, and 410 can be used to measure forces on irregular surfaces (e.g., bumps, scrapes, lesions, ridges, or skin folds of a hand). Further, the sensor networks 200, 300, and 410 can dynamically collect sensor data as the surface 406 flexes and moves. The sensor data 414 can be used by the server 120 to update the enhanced model 404. In some instances, the enhanced model 404 can be updated in substantially real time as the surface 406 moves or changes and the forces are collected by the sensor networks 200, 300, and 410.

After the sensor data 414 is received by the server 120, the server 120 can process the sensor data 414 and update the initial model 402 to generate the updated model 404. The enhanced model 404 is thus constructed to include force measurements in multiple dimensions.

Thus, the enhanced model 404 of the hand 400 includes the surface conditions (e.g., pressure and stress measurements) at known locations on the hand 400. The surface conditions at these known locations can be combined to yield a more accurate map of the pressure on the surface 406 of the hand 400, which is reflected in the enhanced model 404. The construction of the enhanced model 404 combines the three-dimensional aspects of the initial model 402 with the empirical sensor data 414 to determine the surface conditions on the surface 406. In FIG. 4, the surface 406 can include knuckles of hand, ridges of fingers, or the like.

As mentioned previously, the sensor data 414 from the sensor networks 200, 300, and 410 are provided to the server 120 or to the sensor module 122. The sensor module 122 cooperates with the 3D module 126 to enhance the initial model 402 with the sensor data 414 to generate the enhanced model 404, which may be embodied as a pressure map of the surface 406 of the hand 400. The enhanced model 404 provides a more accurate measure of the forces on the hand 400. As the forces on the hand 400 change (due to external pressure change and/or due to the change in motion/orientation of the actual hand 400), the server 120 can re-measure in real time (dynamically) the actual forces on the hand 400 and update the enhanced model 404.

Constructing a model of a surface may include receiving sensor data from a sensor network that is arranged on the surface of an object to measure surface conditions in multiple dimensions. The sensor data thus includes measurements of the surface conditions. After receiving the sensor data, pressure data is determined from the sensor data. The pressure data is correlated to locations in the enhanced model. Then, an initial model of the object is enhanced with the pressure data.

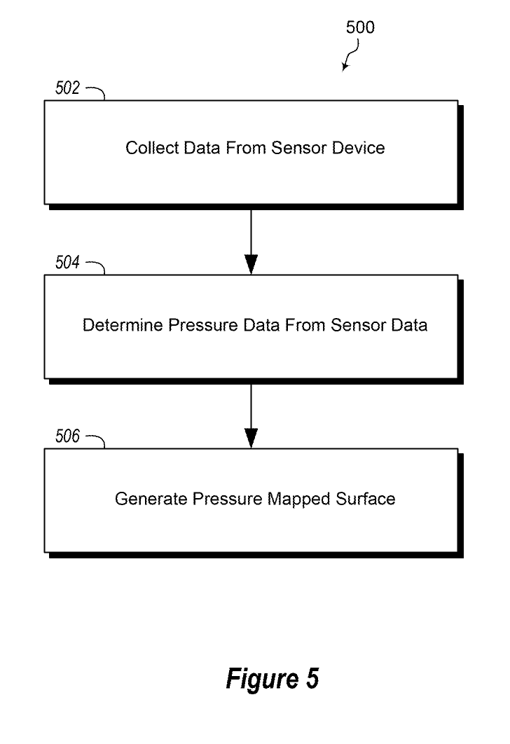

FIG. 5 is a flow diagram of an illustrative embodiment of a method 500 for generating a pressure-mapped surface of an object. In block 502, sensor data is collected from a sensor device. As described herein, the sensor device may include multiple sensors that are interconnected and arranged on a surface of an object. The connections that connect the sensors enable the sensors to generate data that reflects surface conditions on the surface of the object and to provide sensor data that reflects the forces on the surface in three dimensions.

In block 504, pressure data is determined from the sensor data. The pressure data represents a holistic view of the surface conditions. The pressure data can be determined by analyzing the sensor data and correlating the sensor data with the locations on the pressure-mapped surface to which sensors in the sensor device are registered.

In block 506, a pressure-mapped surface are generated from the pressure data. The pressure-mapped surfaces are one example of an enhanced model of a surface. In one embodiment, the pressure-mapped surface can be dynamically updated as the surface conditions change. The sensor device can be monitored continuously or periodically or on command to acquire new sensor data that is processed and used to update the enhanced model of the surface of the object.

Those skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

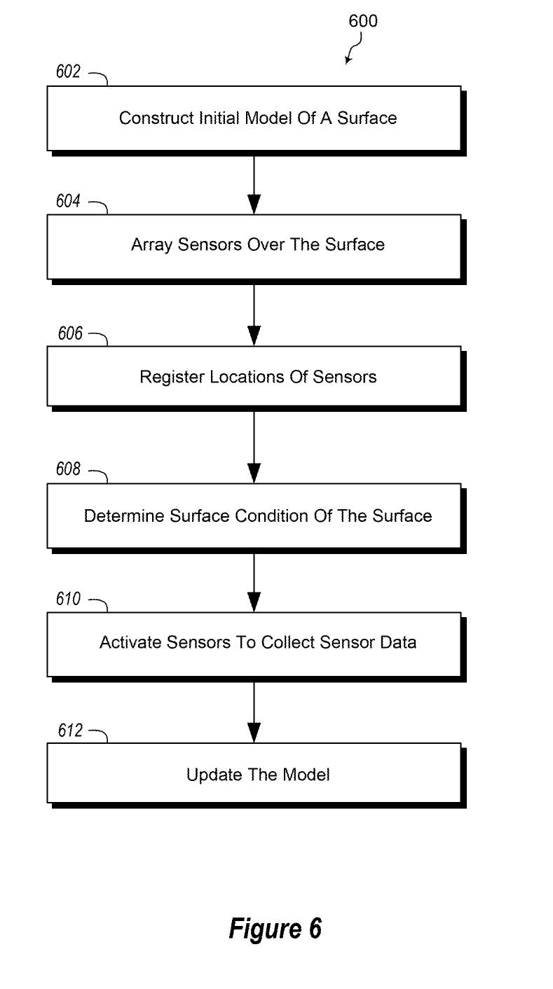

FIG. 6 is a flow diagram of an illustrative embodiment of a method 600 for constructing an enhanced model of a surface of an object. In block 602, an initial model of a surface of an object or of an object is constructed, although an existing model of the object or of the surface of the object may also be used. The initial model can be a three-dimensional model. The initial model can be constructed, by way of example only, through scanning, tactile stimulation, imaging, or other techniques.

In block 604, sensors are arrayed over the surface of the object. This can include placing one or more sensor networks, connecting the sensor networks, or the like or any combination thereof. In one embodiment, the location of each sensor is registered in the initial model. This allows the location of each sensor to be tracked and allows the sensor data from each sensor to correlate with the enhanced model.

The locations on which the sensors are placed can be pre-determined and may depend on the object. For example, the sensor location placement on the hand 400 of FIG. 4 can be dictated by corresponding hot spots shown on the initial model 402. The sensors can be placed in appropriate locations according to the hot spots identified in the initial model 402.

In block 606, the locations of the sensors are registered. Registering the locations of the sensors and/or the sensor networks enables the sensor data to be examined in the context of the surface of the object. For instance, the data from the sensor network 200 can be used to estimate the surface conditions for the area of the surface on which the sensor network 200 is located. If the sensors indicate that a stress force of F exists between two locations on the surface this information can be combined with the known spring constant to estimate the physical displacement (spacing) between those two mesh locations in response to the stress forces. Registering the sensors and/or the sensor networks allows the sensor data and/or the sensor location to be correlated to the model 420.

In one embodiment, sensors can also be randomly or uniformly distributed on the object. Then, the object with sensors already placed can be optically scanned (e.g., using the same scanning process that was used to obtain the 3D virtual hand). In this example, the position of the sensors can be automatically registered and the forces determined from the sensors can be superimposed onto or integrated into the initial model 402 of FIG. 4 to generate the enhanced model 404.

Once the location of the sensors and/or sensor networks are registered, the surface conditions of the surface are determined in block 608. This may be, in one example, the initial surface conditions before the sensors are activated, default conditions, or the like. Determining the initial surface conditions can be achieved using, by way of example, a set of techniques including finite element methods, finite difference methods, spectral analysis, discontinuous Galerkin methods, or a range of other methods to determine the initial surface conditions on the object. These techniques can be used to obtain numerical and visual information about the pressure areas on, for example, the object. For instance, a contour pressure map can be obtained from these models and used as the initial model.

In block 610, the sensors arrayed on the object are activated and sensor data is collected. The sensor networks and/or the sensors can be activated individually or as a whole. For example, the sensor network 200 can be activated to measure the surface conditions for that specific part of the hand 400 in FIG. 4.

In addition, the enhanced model of the object can be constructed using one or more methods with the sensor data combined to produce a hybrid model. For example, different types of sensors, e.g., expensive high resolution sensors or inexpensive low resolution sensors, can be used in such a hybrid model. High resolution sensors may be used in areas of the surface of the object that are more irregular or have more variation or that are expected to experience more movement. Low resolution sensors can be used in areas where the surface is more planar.

In addition, the hybrid model may be generated by considering specific types of sensors independently. For instance, a sensor network of piezoelectric sensors may generate sensor data while a sensor network of optical sensors may generate sensor data separately. The sensor data from these sensor networks can be combined to construct the hybrid model.

In block 612, the sensor data collected from the sensors and/or sensor networks is used to update the initial model to generate a more accurate three-dimensional representation of location and pressure in an enhanced model of the object and/or the surface of the object. The updating of the initial model may be performed based on need, whether real time updating (e.g., millisecond updating), or polling updates (e.g., every few seconds), or updating based on explicit commands to refresh the enhanced model. The enhanced model can be viewed to examine pressures on the surface of the object. The enhanced model can also be sent over networks to recreate the pressure data at a different location. For example, the enhanced model can be used in interactive haptic systems including telemedicine, virtual reality, remote maintenance, robotics, computer gaming or the like.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

In an illustrative embodiment, any of the operations, processes, etc. described herein can be implemented as computer-readable instructions stored on a computer-readable medium. The computer-readable instructions can be executed by a processor of a mobile unit, a network element, and/or any other computing device.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

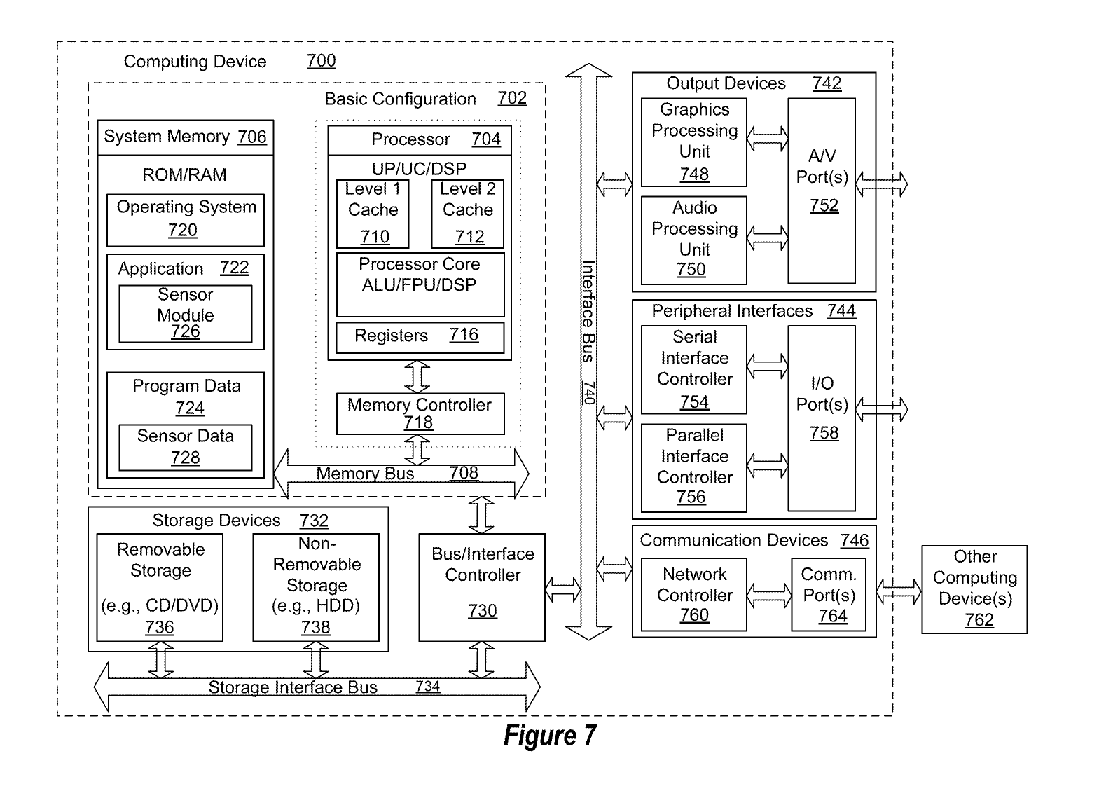

FIG. 7 is a block diagram illustrating an example computing device 700 that is arranged for constructing a model of a surface of an object or for enhancing a model of the surface of the object in accordance with the present disclosure. In a very basic configuration 702, computing device 700 typically includes one or more processors 704 and a system memory 706. A memory bus 708 may be used for communicating between processor 704 and system memory 706.

Depending on the desired configuration, processor 704 may be of any type including but not limited to a microprocessor (μP), a microcontroller (μC), a digital signal processor (DSP), or any combination thereof. Processor 704 may include one more levels of caching, such as a level one cache 710 and a level two cache 712, a processor core 714, and registers 716. An example processor core 714 may include an arithmetic logic unit (ALU), a floating point unit (FPU), a digital signal processing core (DSP Core), or any combination thereof. An example memory controller 718 may also be used with processor 704, or in some implementations memory controller 718 may be an internal part of processor 704.

Depending on the desired configuration, system memory 706 may be of any type including but not limited to volatile memory (such as RAM), non-volatile memory (such as ROM, flash memory, etc.) or any combination thereof. System memory 706 may include an operating system 720, one or more applications 722, and program data 724. Application 722 may include a sensor module 726 that is arranged to perform the functions as described herein including collecting or receiving sensor data from a sensor device. Program Data 724 may include sensor data or pressure data 728 that may be useful for updating a model of a surface to generate an enhanced model of a surface of an object as will be further described below. In some embodiments, application 722 may be arranged to operate with program data 724 on operating system 720 such that implementations of sensing applications may be provided as described herein. This described basic configuration 702 is illustrated in FIG. 7 by those components within the inner dashed line.

Computing device 700 may have additional features or functionality, and additional interfaces to facilitate communications between basic configuration 702 and any required devices and interfaces. For example, a bus/interface controller 730 may be used to facilitate communications between basic configuration 702 and one or more data storage devices 732 via a storage interface bus 734. Data storage devices 732 may be removable storage devices 736, non-removable storage devices 738, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

System memory 706, removable storage devices 736 and non-removable storage devices 738 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 700. Any such computer storage media may be part of computing device 700.

Computing device 700 may also include an interface bus 740 for facilitating communication from various interface devices (e.g., output devices 742, peripheral interfaces 744, and communication devices 746) to basic configuration 702 via bus/interface controller 730. Example output devices 742 include a graphics processing unit 748 and an audio processing unit 750, which may be configured to communicate to various external devices such as a display or speakers via one or more A/V ports 752. Example peripheral interfaces 744 include a serial interface controller 754 or a parallel interface controller 756, which may be configured to communicate with external devices such as input devices (e.g., keyboard, mouse, pen, voice input device, touch input device, etc.) or other peripheral devices (e.g., printer, scanner, etc.) via one or more I/O ports 758. An example communication device 746 includes a network controller 760, which may be arranged to facilitate communications with one or more other computing devices 762 over a network communication link via one or more communication ports 764.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 700 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 700 may also be implemented as a personal computer including both laptop computer and non-laptop computer configurations.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A method for constructing a model of a surface of an object, the method comprising:
receiving sensor data from a sensor network that is arranged on the surface of the object and configured to measure surface conditions, wherein multiple dimensions of the surface conditions are measured by the sensor network and the sensor data includes measurements of the surface conditions;
determining pressure data from the sensor data, wherein the pressure data is correlated to locations in the model; and
enhancing an initial model of the object with the pressure data to generate the model, wherein the model includes the surface conditions measured by the sensor network.

2. The method of claim 1, wherein the sensor network includes a plurality of sensors connected by connections that are used in measuring the surface conditions.

3. The method of claim 2, further comprising registering the sensor network such that locations of each of the plurality of sensors correlates to corresponding locations on the model.

4. The method of claim 2, wherein:
the plurality of sensors includes one or more of piezoelectric devices, optical stress devices that use polymers, electro-mechanical stress devices, stress dependent potentiometers, or spring tension devices with electrical pickup;
the connections have a known elasticity and include at least one of a rubber, a spring, or a synthetic component; and
the surface conditions include forces including one or more of pressure or surface tension.

5. The method of claim 2, wherein distortions in the connections are included in the sensor data.

6. The method of claim 1, further comprising receiving the initial model of the object.

7. The method of claim 1, further comprising updating the model with new sensor data in substantially real time.

8. The method of claim 1, further comprising constructing the initial model of the surface.

9. A system for constructing an enhanced model of a surface of an object, the system comprising:
a sensor device having a sensor network configured to be arranged on the surface of the object;
a sensor module configured to receive sensor data from the sensor network, wherein the sensor data corresponds to multiple dimensions of surface conditions on the surface of the object and wherein the sensor module determines pressure data from the sensor data; and
a three-dimensional module configured to update the enhanced model with the pressure data.

10. The system of claim 9, further comprising a display suitable to display the enhanced model.

11. The system of claim 9, wherein the sensor module updates the enhanced model dynamically when new sensor data is received from the sensor network.

12. The system of claim 9, further comprising a plurality of sensor networks, each sensor network including a plurality of sensors.

13. The system of claim 12, wherein the plurality of sensors in each sensor network are interconnected with connections, wherein the sensor data from each sensor network reflects distortions of the connections and direct pressure on the sensor.

14. The system of claim 9, wherein sensors in the sensor network are placed on locations that are registered with the enhanced model.

15. The system of claim 9, wherein:
sensors included in the sensor network include one or more of piezoelectric devices, optical stress devices that use polymers, electro-mechanical stress devices, stress dependent potentiometers, or spring tension devices with electrical pickup;
the connections have a know elasticity and include at least one of a rubber, a spring, or a synthetic component; and
the surface conditions include one or more of pressure or surface tension.

16. A method for enhancing an initial model of an object with pressure data, the method comprising:
collecting sensor data from a sensor network arranged on a surface of the object, wherein the sensor network includes a plurality of connections that interconnect sensors in the sensor network, wherein the sensor data includes measurements of forces in multiple dimensions experienced by the sensors and by the connections;
correlating the sensor data with locations on the initial model;
generating pressure data from the sensor data, wherein the pressure data reflects directions of the forces in three dimensions; and
constructing an enhanced model of the object by enhancing the initial model with the pressure data.

17. The method of claim 16, further comprising collecting the sensor data from a plurality of sensor networks arrayed on the surface, wherein the sensor data is collected on a per sensor network basis, or on a per sensor basis.

18. The method of claim 16, further comprising registering the sensor network such that the sensors correlate to pre-determined locations on the enhanced model.

19. The method of claim 16, further comprising sending the enhanced model to a remote location.

20. The method of claim 16, wherein:
sensors included in the sensor network include one or more of piezoelectric devices, optical stress devices that use polymers, electro-mechanical stress devices, stress dependent potentiometers, or spring tension devices with electrical pickup;
the connections have a know elasticity and include at least one of a rubber, a spring, or a synthetic component; and
the forces include one or more of pressure or surface tension.
